(19) United States
(12) Patent Application Publication
(10) Pub. No.: US 2006/0179046 A1
(43) Pub. Date: Aug. 10, 2006

(54) Web operation language

(75) Inventors: Anand Rajaraman, Palo Alto, CA (US); Venky Harinarayan, Saratoga, CA (US); Ram Subbaroyan, San Francisco, CA (US); Subramanyam Mallela, San Francisco, CA (US)

Correspondence Address: VAN PELT, YI & JAMES LLP, 10050 N. FOOTHILL BLVD #200, CUPERTINO, CA, 95014, US

(73) Assignee: Cosmix Corporation

(21) Appl. No.: 11/332,845

(22) Filed: Jan. 13, 2006

Related U.S. Application Data
(60) Provisional application No. 60/644,320, filed on Jan. 14, 2005.

(51) Int. Cl. G06F 17/30

(52) U.S. Cl. 707/3

(57) ABSTRACT

Operating on a web data store is disclosed. The web data store includes link and page information. A web operation to be applied to the web data store is sent. Results of the web operation applied to the web data store is received. Optionally, a plurality of operators is composed into an expression.

### CROSS REFERENCE TO OTHER APPLICATIONS

This application claims priority to U.S. Provisional Patent Application No. 60/644,320 entitled ALGEBRA FOR THE WORLD-WIDE WEB filed Jan. 14, 2005 which is incorporated herein by reference for all purposes.

### BACKGROUND OF THE INVENTION

Large-scale web data applications are typically built in a custom manner from scratch. At most, they use the file system service provided by the operating system, and in many cases, proprietary file systems are used. Additionally, large-scale web data applications typically use custom methods of data and computation distribution. One reason for this is that the massive data volumes and types of operations performed on the data do not lend themselves to using available off-the-shelf components.

There is thus a need for a better platform on which web data applications may be built.

### BRIEF DESCRIPTION OF THE DRAWINGS

Various embodiments of the invention are disclosed in the following detailed description and the accompanying drawings.

FIG. 1 illustrates an embodiment of a platform for web data applications.

FIG. 2A is an illustration of an embodiment of a process for implementing a web data application.

FIG. 2B is an illustration of an embodiment of a process for responding to a web operation request.

FIG. 3A illustrates an example of an operator tree that computes a binary relation.

FIG. 3B illustrates an example of an operator tree.

FIG. 4 illustrates an example of an operator tree.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. A component such as a processor or a memory described as being configured to perform a task includes both a general component that is temporarily configured to perform the task at a given time or a specific component that is manufactured to perform the task. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A data model and a web operation language form the basis of a platform for web data applications.

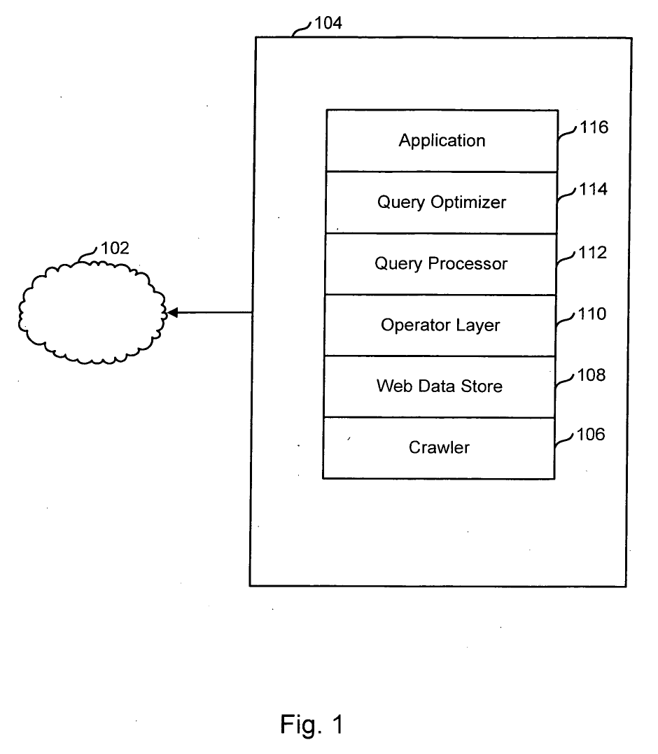

FIG. 1 illustrates an embodiment of a platform for web data applications. In the example shown, collection 102 is a group of World Wide Web pages, and is crawled by and indexed by platform 104. The documents in collection 102 are also referred to herein as “web nodes” and “web pages.” In some embodiments, the documents in collection 102 can include, but are not limited to text files, multimedia files, and other content. In some embodiments, collection 102 includes documents residing on an intranet. Platform 104 may be a single device, or its functionality may be provided by multiple devices.

Platform 104 includes a crawler 106 that crawls documents in collection 102 and processes the retrieved documents. For example, crawler 106 extracts content and link information, storing the information as appropriate in web data store 108. In some embodiments, crawler 106 is aided by other components, such as an indexer, not shown. In some embodiments, portions 106 to 116 of web application platform 104 are implemented in a single computer. In other embodiments, portions 106 to 116 are spread across a plurality of computers, which may or may not be in close proximity. For example, crawler 106 may reside separately from application 116. Similarly, network access to web data store 108 may be provided, such as via a subscription, rather than a complete web data store residing on the same computer as application 116.

In addition to the typical atomic types (e.g., integers, floats, etc.), the data model employed by platform 104 includes three data types that aggregate elements of atomic types. These aggregate data types include relations, text, and tagged matrices. In this example, relations follow the usual relational model, and may include columns that are of the text type. Text is a sequence of characters. Tagged matrices are matrices (and, as a special case, vectors), whose rows and columns have “tags” or keys associated with them.

Web data store 108 includes information related to the documents in collection 102, such as page content and link information. Here, the crawled web data is encoded in two special relations. In some embodiments, the crawled web data is actually stored in the following relations. In other embodiments, the web data relations are merely conceptual—a logical view of the data stored in web data store 108.

The first, called the “pages relation,” models metadata about web pages. For each document in collection 102, information such as a pageID, a URL, the document's content type, content length, content, number of inlinks, number of outlinks, etc., may be included. In this example, the content is the raw page data (e.g., the raw HTML, raw PDF, etc.). The pages relation can be conceptualized as a copy of each of the documents in collection 102, with additional meta-information about the documents also stored. In the example shown, all of the other attributes (e.g., pageID) are atomic. In some embodiments, pageID is the primary key. In some embodiments, the URL field is used as a key. Other information, such as different versions of a page—as crawled at different times or on different days—can also be included in the pages relation.

In some embodiments, the content is tokenized and information such as the words appearing in the document are stored in another relation (e.g., a “parsed pages relation”). As described in more detail below, parsing raw pages may also be performed, such as by a third party, using one or more operators in the web operation language. Thus, it is possible to create additional relations by using web operators on the existing relations.

The second relation, called the “links relation,” contains a representation of the link structure of collection 102. Thus, information such as linkID, sourceID, destID, anchorText, etc. may be included in the links relation. In some embodiments, the links relation also tracks multiple links between the same pages.

Operation layer 110, query processor 112, and query optimizer 114 facilitate the execution of one or more applications, such as application 116, which can be used to manipulate the contents of web data store 108 using one or more operators.

The operators may be selected from a provided web operation language, or they may be created for custom applications. As used herein, “operator” and “query” may be used interchangeably, as appropriate. In some cases, algebraic operators are embedded in a conventional programming language (referred to herein as the host language) such as C or Java, so that arbitrary data sets may be iterated over and computations may be performed in the host language (e.g., the cursors in the relational world).

In this example, query optimizer 114 optimizes operators into operator trees in the host language. In some embodiments, query optimizer 114 is omitted. Example applications include, but are not limited to, personalized search, flavored search, table extraction, feature extraction, question answering, and expert systems. Applications can also be built that combine web data with other information, such as enterprise data.

Web Operation Language

A language typically provides a collection of operators that can be used to form expressions. A web operation language, comprising one or more of the following operators can be used to express a wide assortment of useful computations. The web operation language is also extensible, so more operators can be added as needed.

Operators can be grouped by the aggregate data type(s) with which they are associated. Some examples include relational operators, text operators, matrix operators, and operators that work across relations and text, and across relations and matrices.

Relational operators take one or more relations and Boolean conditions on relation attributes and return a relation. Example relational operators include the following:

SELECT (σ)

PROJECT (π)

CROSS PRODUCT

JOIN ( [symbol] )

INTERSECT (∩)

UNION (U)

DIFFERENCE (−)

RENAME (ρ)—rename columns and relations

TAU (τ)—sort operator

DELTA (δ)—duplicate elimination

GAMMA (γ)—aggregation

The aforementioned set of operators is not minimal—some of the operators can be expressed in terms of others (e.g., a join can be achieved by using cross product and select).

Additionally, a prune operator can be defined to prune results. The prune operator can be used, for example, in query optimization, and can be useful for the common activity of providing, e.g., the first 10 results of a query:

PRUNE (φ). φk (R) returns the first k tuples in R

In some embodiments, φj,k (R) returns tuples at positions j+1 through k, which allows for the extraction of any intermediate sequence of result tuples. The same effect can also be achieved using the first version of PRUNE as well: φj,k (R)=φk (R)−φj (R).

Text operators can return Boolean, text, or relations. Example text operators include the following:

CONTAINS(text, phrase)—which returns true if the text contains the given phrase, false otherwise.

MATCHES(text, regex)—which returns a relation with columns corresponding to the matches of the regex (e.g., the matching portion of the text, and matches corresponding to any parenthesized portions within the regex etc).

Operators that return HTML elements e.g., title, img links, bold sections, etc. These operators return may return text or relations as appropriate.

Operators that break up text into pieces e.g, ONE-GRAMS(text)—which returns a relation with one column, with one row per 1-gram.

TAG(R, key, textCol, TextOp).

In the above “TAG” operation, “key” is a key attribute of R and textCol is a column of type text. TextOp is an operator that operates on text and returns a relation. The TAG operator returns a relation with one more column than TextOp: each row in the result of applying TextOp is extended with the corresponding key value from R.

A “tagged matrix” means a matrix each of whose rows and columns are “tagged” with a key. Rows and columns can be accessed by ordinal number as well as by key. A typical web graph is a very large, sparse matrix, and operators in the web operating language can be optimized for this case. Example matrix operators are as follows:

MATRIX (μ).

A matrix can be created from a relation (e.g., the links relation) using the MATRIX (μ) operator.

The MATRIX operator takes four arguments: two unary relations, “Rows” and “Cols,” a ternary relation R(A,B,V), and a real number c. Rows and Cols represent the sets of row and column tags of the matrix. Whenever there is a tuple (a,b,v) in R, the entry in cell [a,b] of the matrix is v. All other cells in the matrix are set to be equal to c (or 0, if c is omitted). (A,B) is a key for the relation R.

Variants of the μ operator can also be included in the web operation language. For example:

μrow (Rows, Cols, R, c).

Here, R(A,V) is a binary relation. Rows and Cols represent the sets of row and column tags of the matrix. Whenever there is a tuple (a,v) in R, all cells in the row with row tag a are set to value v; all other cells are set to the default value c.

μcol (Rows, Cols, R, c).

Here, R(A,V) is a binary relation. Rows and Cols represent the sets of row and column tags of the matrix. Whenever there is a tuple (a,v) in R, all cells in the column with column tag a are set to value v; all other cells are set to the default value c.

As a special case, the μ operator can also operate on a binary relation R(A,B), instead of a ternary relation; whenever there is a tuple (a,b) in R, the entry in cell [a,b] of the matrix is 1, and all other cells in the matrix are set to zero. Similar variants also exist for μrow and μcol.

TABLE (θ)

The inverse table operator converts a tagged matrix into a ternary relation. The following identity holds for ternary relation R: θ(μ(R))=R.

A vector is a 1-column matrix. As a special case, the column tag can be dropped for the single column of a vector, and the vector may be encoded as a binary relation R(A,V), with key A. The μ and θ operators can be applied to vectors as well as matrices. Here, vectors are denoted using primes to distinguish the two cases): μ′ converts a binary relation into a vector and θ′ converts a vector into a binary relation.

ψ(PSI) and ψ′ (PSI PRIME)

Operators to convert a matrix into a row- or column-stochastic matrix, while potentially redundant, can be useful. The ψ (PSI) operator converts a matrix into a row-stochastic matrix, while ψ′ (PSI′) converts a matrix into a column-stochastic matrix.

Operators to extract a sub matrix of a matrix, based on tags as well as ordinals.

Standard linear algebra operators for matrices and vectors (one-column matrices): addition, multiplication, etc.

In some embodiments, matrices must have the same tag-sets and get automatically “lined up” based on their tags.

EIGENVEC(M) and EIGENVAL(M)

EIGENVEC(M) computes the primary (first) eigenvector of square matrix M; the vector retains M's row tags. EIGENVAL(M) returns the first eigenvalue of M. Other operators may be used to compute the set of all eigenvectors and eigenvalues, or the first k eigenvectors and eigenvalues.

Singular value decomposition

This operator provides three outputs—the left and right singular vectors and the unitary matrix.

The web operation language is extensible. The above operators are some examples of operators that are useful when manipulating a web data store.

Web Operation Language—Cursors

In the context of a relational database management system, “cursors” are iterators used to step through result sets. When a relational query is executed, the result is a relation. When embedded in a programming (“host”) language such as C or Java, what is really returned from a query is a cursor. The cursor has a “next” operation to step through each result, and further methods to examine the contents of each result tuple. If the cursor is opened “for update,” the underlying tuple can be modified by operating on the cursor representation of each tuple.

In the web operation language, in addition to returning a relation, a query may also return a matrix or a text object. Cursors can be devised to “step through” matrices and text as well. For example, matrix cursors can step through a matrix both row-at-a-time and column-at-a-time. Text cursors step through text one character at a time, one word at time, one HTML element at a time, and so on.

In each case, updates may be allowed through a cursor as well. This allows for support of new operations that are not directly supported in the web operation language. For example, suppose the median value of each row in a matrix is to be determined; a cursor may be used to step through the matrix row-at-a-time and compute the medians. If desired, the web operation language can be extended to allow for future median computations by making the computation available as a new matrix operator.

In some embodiments, the host language API contains a flag to specify whether the object is a “named object” persisted to disk or a transient one to be housed in memory. In some embodiments, a catalog is made available that lists and describes all persistent named objects.

Application Examples

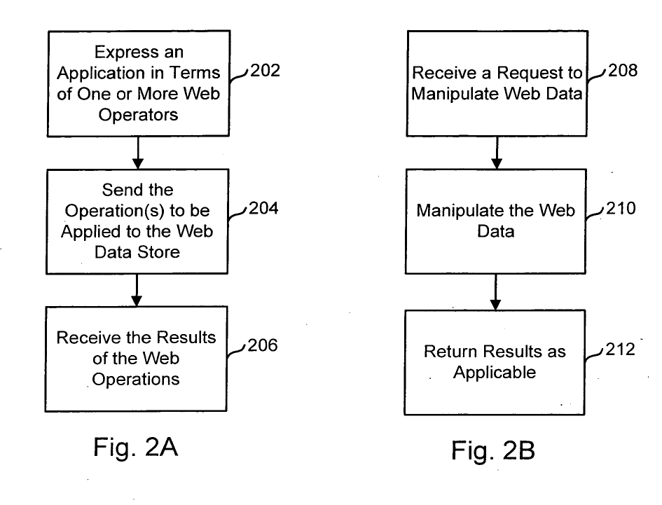

FIG. 2A is an illustration of an embodiment of a process for implementing a web data application. The process may be implemented on web application platform 104. The process may also be implemented by a third party, and, for example, executed on a corporate intranet, which is in communication with web application platform 104 and/or web data store 108.

The process begins at 202 when a web application, such as application 116, is expressed in terms of one or more web operators. Several examples of applications 116 (such as search, question answering, etc.) are given below and expressed in example web operators. In some cases, application 116 is pre-defined and resides on the web application platform 104. This may be the case, for example, with typical applications such as basic search engines. In some cases, a basic (off-the-shelf) application is further customized, or is built from scratch by a third party. In some embodiments, application 116 operates in conjunctions with a set of templates or other options which allow for the rapid personalization of the application.

At 204, the operation(s) are submitted for processing on web data store 108. For example, the operation(s) may be submitted to web application platform 104 by a user via a web interface. In some cases, at least some of the operation(s) may be batch processes. In some cases, the operation(s) may be optimized by query optimizer 114 prior to their execution.

As described more fully in conjunction with the application examples given below, at 206, results of the web operations are returned.

FIG. 2B is an illustration of an embodiment of a process for responding to a web operation request. The process may be implemented on web application platform 104.

The process begins at 208 when one or more web operations is received. These operations form a request to manipulate web data in web data store 108. At 210, data in web data store 108 is manipulated in accordance with the presented web operation request. As described more fully in conjunction with the application examples given below, at 212, results of the attempted manipulation are returned to the requester, as appropriate.

Example—Computing Page Rank

Two aspects to implementing a simple web search application in which results are sorted according to classic Page Rank are as follows. First, the Page Rank of every page must be computed. This computation is done periodically “offline” as a batch job. Second, each request must be responded to. This operation is done in real-time and uses the computed and stored Page Rank values.

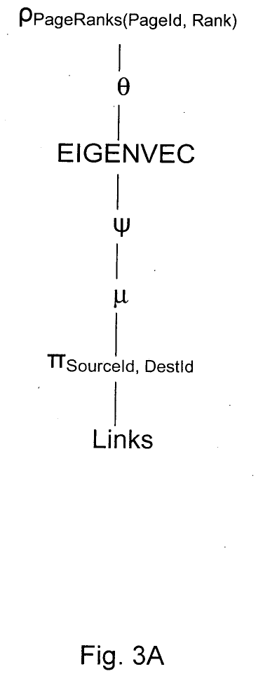

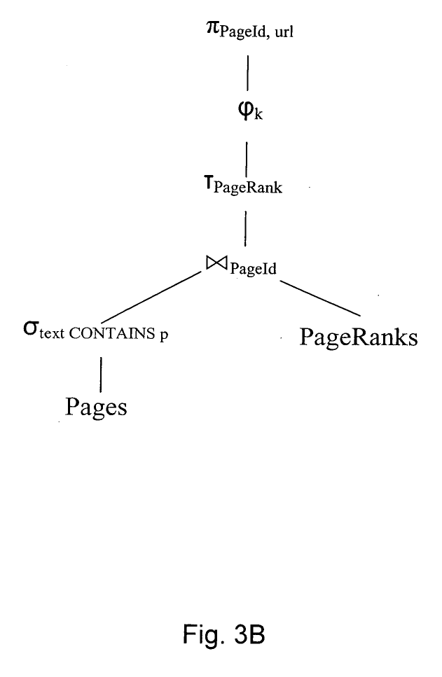

FIG. 3A illustrates an example of an operator tree that computes a binary relation. In this example, the binary relation is PageRanks(pageID, Rank). This portion addresses the computing Page Rank aspect of the desired application.

FIG. 3B illustrates an example of an operator tree. In this example, pages are searched for the presence of phrase p, and the first k resulting pages are ordered by Page Rank (e.g., a first result page).

In some embodiments, the titles and snippets of the pages that match are also obtained. To run in real-time, in some embodiments, platform 104 maintains an index of Page Ranks that allows fast lookup by pageID and a text index on the pages relation. In some embodiments, the query is optimized by query optimizer 114 to “push down” the projection and prune down the tree to minimize computation. Appropriate text operators can optionally be used to weight the text match by such things as whether phrase p appears in the title, or in boldface.

Example—Question Answering

Suppose a user desires an answer to the question, “What is the Height of Mount Everest?” One way to answer such a question is as follows: Find all pages that, contain the phrase “Mount Everest.” Now find all numeric values in those pages that can possibly represent heights. Order the numeric values according to how frequently they occur. The top value is the height of Mount Everest.

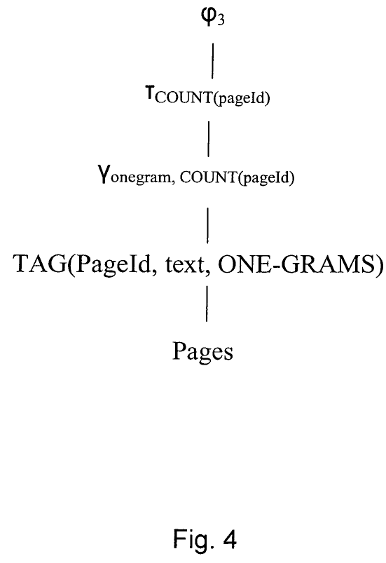

FIG. 4 illustrates an example of an operator tree. In this example, ONE-GRAMS returns a unary relation with the single column onegram, so the TAG operator returns the binary relation (pageId, onegram).

The aggregation operator gamma returns a relation with two columns. The first column is a onegram, and the second is the number of pages containing that one-gram. In some embodiments, rather than all one-grams, numbers are exclusively used. One way of doing this is to use the MATCH operator, e.g., MATCH(“\d+”), rather than the ONE-GRAM operator.

In some embodiments, rather than counting the number of occurrences of terms, they are weighed, e.g., using tf-idf. The results can be achieved in two steps. In the first step, a temporary relation is constructed that contains the document frequency of each term. In the second step, an expression tree such as the one depicted in FIG. 4 is used, however multiplication by idf is used instead of COUNT.

Example—Flavored Search

The Page Rank example above can be implemented as a successive sequence of assignments, where earlier results are used to compute later results. The notation used below is slightly different from the operator tree notation used above. Unbiased Page Rank can be considered a “vanilla” search. As described in more detail below, flavored searches can also be formed, such as geographic flavors and content flavors.

Vanilla Search

For a vanilla search, first compute the set of all nodes and edges in the graph. In this example, this is just the set of all pages and links:
Nodes=π_{PageID}(Pages)
Arcs=π_{SourceID,DestID}(Links) (1)

Portion A of the transition matrix corresponding to the links (i.e., no random teleports) is then computed. In this example, a matrix is constructed with both row set and column set Nodes, a 1 for every link in Arcs, and 0 elsewhere, as follows:
A=μ(Nodes, Nodes, Arcs, 0) (2)

The uniform random teleportation matrix B can be constructed as follows. In this example, there is an empty relation as a third argument, so all entries are set equal to 1.
B=μ(Nodes, Nodes, ø, 1) (3)

Finally, both matrices are made stochastic and are added with appropriate weights to obtain the transition matrix M. Matrix addition and multiplication are operators in the web operation language. In this example, beta is a number between 0 and 1 (typically 0.85):
M=β*ψ(A)+(1−β)*ψ(B) (4)

The eigenvector of the transition matrix M can now be computed and converted into a relation. In this example, transpose is a matrix operator.
PageRank=ρ_{PageID,Rank}(θ(EIGENVEC(M^{T})) (5)

All the operators used above can be implemented as efficient sparse matrix operators. In the above example, though, the matrices M and B are not “sparse” in the traditional sense because they have very few non-zero entries. Matrix B has no non-zero entries; every cell is equal to 1. However, the number of independent (i.e., distinct) values that appear in the matrix is similar to a traditional sparse matrix. A matrix with many entries equal to a constant can be represented very concisely, for example by storing the row and column tags and the single constant value. A similar method can be used for matrices with very few distinct values, and for some of the flavoring matrices that follow. One measure of sparseness of a matrix is the storage space required to store it, and by this measure all of the matrices described above are sparse.

Geographic Flavoring

Geographic flavoring occurs when the teleportation matrix is altered to bias it in favor of some nodes. For example, consider the general case in which the probabilities for teleportation are stored in a binary relation T(A,P). Tuple (a,p) denotes that the teleportation probability into node a is p. In this example, nodes that have zero teleportation probability are omitted, so T only contains tuples for nodes with non-zero teleportation probability.

One way to create a geographic flavoring computation is to modify the vanilla Page Rank computation as follows. Instead of computing the teleportation matrix B as above, use the following:
B=μ_{col}(Nodes, Nodes, T, 0) (6)

The remainder of the computation remains the same. In this example, the μ_{col} operator sets whole columns of the matrix B to the values specified in T.

Content-Based Flavoring

Content-based flavoring occurs when the link transition probability is altered based on the content of the target (or source) page or hyperlink. For example, consider the case where for each node there exists an in-transition probability multiplier, encoded in relation Mult(PageID, Factor). Tuple (p,f) denotes that the probability multiplier for page p is f. For example, the multiplier for pages containing the term “cat” could be 2, while it is 1 for all other pages. In some embodiments, Mult is itself computed using the text and relational operators in the web operation language.

One way to create a content-based flavoring computation is to modify the vanilla Page Rank computation as follows. Instead of computing the matrix Arcs as above, use the following:
Arcs=π_{SourceID,DestID}(Links) [symbol] _{DestID=PageID}(Mult) (7)

In this example, the resulting ternary Arcs relation will have a “weight” on each link, and so the subsequent u operator will place those weights in matrix A rather than the default value of 1.

Additional Examples

Virtually any web mining application may be built using platform 104. One example is an application that extracts structured information from the web, or extracts unstructured information from the web and automatically applies structure subsequently. Suppose it would be desirable to create a relational table that lists every drug side effect, which companies manufacture the drug, whether it is available in generic form, etc. The information could be mined from the web, and, for example, merged with other information to generate a new relation that could be used by consumers, doctors, etc.

Product reviews could be periodically mined from the web and automatically inserted into a personal web page. For example, a kayak aficionado may use the platform to periodically mine reviews of particular kayak models and have new reviews inserted into an RSS feed and/or a “Latest Reviews” section of a website. Product reviews could also be served by a customized search engine in response to real-time queries. For example, a user interface could be provided in which a user enters a product name, and at the user's option, negative reviews, positive reviews, etc. could be provided. The data could also be combined with localization information, for example showing the user where the five closest stores with the product in inventory are located.

A company could periodically mine the web for comments about the company—whether negative and/or positive. For example, a movie studio can mine for reviews of films and have the results automatically compiled into “best comments” and “worst comments” lists. A public relations firm can mine for client names, and receive alerts when a threshold amount of “buzz” is generated about a client.

Custom applications may be supplied for processing on the platform by third parties. In this example, an end user may pay a subscription fee to access the platform. In other cases, the relations, the web operation language, and/or other sub components of platform 104 are licensed independently.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method of operating on a web data store comprising:
sending a web operation to be applied to the web data store; and
receiving results of the web operation applied to the web data store;
wherein the web data store includes link and page information.

2. The method of claim 1 wherein the web operation is selected from a web operation language.

3. The method of claim 1 wherein the web operation includes at least one of: select, project, cross product, join, intersect, union, difference, rename, tau, delta, gamma, prune, contains, matches, return HTML element, break up text, tag, and matrix.

4. The method of claim 1 wherein the web data store includes link and page information related to documents on the World-Wide Web.

5. The method of claim 1 wherein the web data store includes link and page information related to documents on an intranet.

6. The method of claim 1 wherein the web operation is used at least in part to determine the properties of a graph.

7. The method of claim 1 wherein the web data store is operated on as part of a search engine application.

8. The method of claim 1 wherein the web data store is operated on as part of a product review application.

9. The method of claim 1 wherein the web data store is operated on as part of a web mining application.

10. The method of claim 1 further comprising composing a plurality of operators into an expression.

11. A method of manipulating web data comprising:
providing access to a web data store to third parties via a web operation language;
receiving a request in a web operation language to manipulate at least some web data; and
manipulating at least some web data in accordance with the web operation language request.

12. The method of claim 11 further comprising storing link and page information in a web data store.

13. A method of building a web application for a platform comprising:
selecting an application; and
expressing the application in terms of one or more operators;
wherein the operators are provided in a web operation language and the platform provides access to a web data store including page and link information.

14. The method of claim 13 wherein the application includes providing structure to information mined from the web.

15. The method of claim 13 wherein the application is a web mining application.

16. The method of claim 13 wherein the application is a search engine.

17. A system for operating on a web data store comprising:
a processor configured to:
provide access to a web data store to third parties via a web operation language;
receive a request in a web operation language to manipulate at least some web data; and
manipulate at least some web data in accordance with the web operation language request; and
a memory coupled with the processor, wherein the memory provides the processor with instructions.

18. The system of claim 17 wherein the processor is further configured to store link and page information in a web data store.

19. A computer program product for manipulating web data, the computer program product being embodied in a computer readable medium and comprising computer instructions for:
providing access to a web data store to third parties via a web operation language;
receiving a request in a web operation language to manipulate at least some web data; and
manipulating at least some web data in accordance with the web operation language request.

20. A computer program product as recited in claim 19, the computer program product further comprising computer instructions for storing link and page information in a web data store.
